(19) United States
(12) Patent Application Publication
(10) Pub. No.: US 2023/0244437 A1
(43) Pub. Date: Aug. 3, 2023

(54) SYSTEMS AND METHODS TO ADJUST LOUDNESS OF CONNECTED AND MEDIA SOURCE DEVICES BASED ON CONTEXT

(71) Applicant: Rovi Guides, Inc., San Jose, CA (US)

(72) Inventors: Serhad Doken, Bryn Mawr, PA (US); Reda Harb, Bellevue, WA (US)

(21) Appl. No.: 17/587,615

(22) Filed: Jan. 28, 2022

(51) Int. Cl. G06F 3/16; H04R 3/12; H04R 29/00

(52) U.S. Cl. CPC G06F 3/165; H04R 3/12; H04R 29/002; H04R 2430/01

(57) ABSTRACT

Systems and methods are disclosed for controlling one or more devices based on measured sound levels. A device management system may access managed devices on a network, determine if any managed devices are generating sound, identify the sound-generating device, access a loudness policy associated with the sound-generating device, select a sound measuring device near the sound-generating device, receive from the sound measuring device a measured sound level of the sound-generating device, determine if the measured sound level exceeds a threshold from the loudness policy, and issue a command to the sound-generating device to reduce the volume. The sound measuring device may be selected because it is close to or in the same room as the sound-generating device. A management system may set and store a sound level limit as a loudness policy for a device, room, building, community, or more.

### BACKGROUND

The present disclosure relates to controlling devices, and more particularly to systems and related processes for controlling levels of audio output in response to measured sound levels.

### SUMMARY

Consuming media can be experienced in various environments at home, work, travelling, etc. One viewer's enjoyment of content, however, may become a distraction or nuisance to another person if, e.g., generated noise is too loud. Whether content is noisy enough to be heard in an adjacent room, a nearby apartment, an office down the hall, a neighboring home or otherwise overheard within a community, another person's loud content can penetrate a person's private space and interfere in his or her life. Controlling levels of sound-generating devices, such as televisions and/or streaming devices, may now be performed remotely, via network connections. Devices in a “smart home” can measure data and communicate data make adjustments in response to received data. An abundance of network-connected microphones associated with devices such as phones, tablets, remote controls, speakers, virtual assistant devices, and more make dynamically measuring sound levels at various locations more possible and practical. Using sound detection and remote commands, a system can automatically correct the volume of a neighbor's during a war film if his blaring subwoofer can be heard next door. There exists a need for a smart home management system capable of controlling sound-generating devices based on received sound level measurements and programmable audio sound level policies.

The development of household devices and connectivity among such devices, as well as digital transmission of media content, has increased the amount of content that can be consumed, as well as the number of locations for consumption. Situations can get pretty loud at times. Homes can have multiple speakers in every room for music and videos. Apartment buildings and condominiums may include media consumers in every room and/or unit, every evening. Office workers may be videoconferencing in thin-walled cubicles or offices. Teenagers and young adults may play their music too loud. Elderly viewers may, unfortunately, over-increase the TV volume to better hear dialogue. Neighbors may hold dance parties with loud streaming music at late hours. Commercials played on the TV in the adjacent hotel room may be obnoxiously louder than the program, used as a blatant technique to attract audience attention to a cheaply produced product or service. Sports and other competitions may cause a crowd noise tracks to crescendo at a single, undesirable, time of day. Sudden loud noises can frighten people. Subwoofers may produce realistic explosion sounds that can reverberate down the hall. Many people may say that listening to one's neighbor's media at any volume, let alone at potentially room-shaking or headache-inducing levels is not desirable.

Generally, sound levels may be measured as sound pressure—also referred to as sound intensity or sound power—in decibels (dB). A sound wave with a larger amplitude than another sound wave will have more energy and will move air particles in its path more, so the sound wave with a larger amplitude is referred to as a more intense sound. The decibel scale is logarithmic, e.g., if a sound is 80 decibels, and another 10 decibels are added, the sound will be ten times more intense, and will seem about twice as loud to human ears. Everyday activities such as normal breathing (10 dB), a soft whisper (30 dB), a refrigerator hum (40 dB), or normal conversation (60 dB) won't cause hearing damage and may not bother most people. Some more annoying noises, such as a washing machine or a dishwasher (70 dB) or city traffic (80-85 dB) may be bothersome to some people. Louder noises like lawnmowers and leaf blowers (85 dB), motorcycles (95 dB), car horns (100 dB), subway trains (100+dB), may cause hearing loss with prolonged exposure, while sirens (120 dB) and fireworks (140-150 dB) may cause injury and pain. With regard to household devices like radios, stereos, televisions, speakers, etc. the maximum volume level is typically 105-110 dB, which could be dangerous. However, overhearing playback of content in the range of 65-85 dB may certainly be annoying to many people.

Personally guarding against loud sounds from surrounding sources is not enjoyable. Scolding a child to turn down her rock music can be tiresome. Asking a hearing-impaired family member to lower the volume of a dialogue-heavy film is not ideal. Enforcing loudness rules in a high-rise condominium building or a densely crowded living community—e.g., with post facto warnings and fines—does not soften the noise quickly enough and could lead to uncomfortable confrontations. There exists a need to measure and regulate devices' noise level without manual interference.

The development of household devices and connectivity among such devices, has also increased the techniques and quantity of data that can be transmitted to and from various devices. More specifically, many household devices can communicate over a network and provide information to a controller about operations being performed by the household devices, as well as information about handling such operations and a condition of the household device and contents or objects associated with the device during and after the operation performance. For example, Internet of Things (“IoT”) devices may be able to communicate over a network allowing a user to access device functionality from another location.

A “smart home” may include, for instance, network-connected televisions, monitors, phones, watches, remote controls, voice-controlled speakers, streaming media players, cameras, security devices, lights, fans, thermometers, thermostats, vacuums, scales, health monitors, and more. Such smart devices may communicate with each other in several ways, e.g., directly, via a hub, and/or via cloud servers. For instance, certain speakers and lights in a smart home may be activated by actions like a TV being turned on or a particular program being selected. Settings for a smart home may be configured to allow, e.g., streaming video only during certain hours, vacuums programmed to run on certain days, and/or security cameras to be triggered on detected motion. Moreover, content delivery systems may transmit metadata between and among devices that may include detailed information about media content. Such metadata may include descriptions and tags to contents within the media asset, as well as other identifying information such as an audio fingerprint. While this information, by itself, may not always be usable for conveying to a human user, computers may be able to read and interpret some metadata. For instance, some data might describe playback details an audio volume of playback.

One approach to try to control loudness of smart home devices may be to set limits for volume settings. Such an approach may not work because devices may be playing content louder than expected. The sound-generating device may be connected to multiple self-powered speakers boosting a song file that may have already been pre-amplified digitally. A smart hub may set a limit on maximum volume bar, e.g., 70%, at certain times, such as between 10 p.m. and 9 AM. Likewise, devices may communicate their volume level for checking. Controlling loudness of smart home devices via communication with playback devices self-reporting their own volume would be inconsistent at best. For instance, a smart home hub may request via network connection from a smart speaker device in a child's room the current playback volume level, e.g., 0-10, of some streaming music to determine if it is louder than a permitted threshold. That level may be different than a television level of 0-35 or a guitar amplifier that may go up to 11. Moreover, such approaches would not necessarily take into consideration any fluctuation in normalization of the music, whether any additional amplifiers are being used, and/or any actual measurements of loudness. Setting a maximum volume level at 75% would not likely prevent digital and/or analog amplification and the loudness could likely exceed the desired limits. Modification of playback devices to include additional amplifiers and bypass the rules and policies would be too easy. There exists a need to measure actual sound loudness to determine whether noise limits are being exceeded.

As described herein, smart device management (SDM) platform may allow the setting of sound level policy limits for certain devices, rooms, areas, office, floors, buildings, communities and more. When a sound level is measured to exceed a policy limit, a command can be sent to the violating device to lower its volume. For instance, a policy for a child's room may include a sound level limit of 55 dB after 8 p.m. and a streaming audio player that reaches 57 dB will be sent a command to lower its volume. A policy for a hotel building may have a sound level limit of 65 dB after 11 p.m., so when a television in room 333 is measured at 70 dB, a command may be sent to the TV to lower its volume.

A SDM platform may be generally used to receive sound level measurement, compare sound levels to loudness policies, and control a device's volume when the sound levels exceed the policy. An SDM system may utilize one or more devices with a microphone like cellphones, tablets, smart speakers, etc. to measure sound levels of a device in the room. For instance, such devices may be configured to measure sound levels, access a sound policy for a device or room, and trigger a command to reduce the volume of the sound-generating device if the measured sound level exceeds a sound policy. In some embodiments, voice-activate remote controls for each television may be used as, e.g., it has a microphone and is usually placed near the television. Remotes may be in communication with a networked television, and able to access a management server in such a manner. Such remotes may be configured to be rechargeable (and/or wirelessly recharged) so that the remotes may take measurements often. Likewise, smart speakers and virtual assistant hubs are typically plugged in all the time and can regularly sample noise levels. Smartphones are suitable for use as sound measurement devices, but there may need to be privacy controls and an opt-in option.

In some embodiments disclosed herein, a SDM engine may access managed devices on a network, determine if any managed devices are generating sound, identify the sound-generating device, access a loudness policy associated with the sound-generating device, select a sound measuring device near the sound-generating device, receive from the sound measuring device a measured sound level of the sound-generating device, determine if the measured sound level exceeds a threshold from the loudness policy, and issue a command to the sound-generating device to reduce the volume.

In some embodiments disclosed herein, a SDM engine may control a device based on measured sound levels by determining a sound device, of a plurality of devices, is outputting a sound, selecting a measuring device, from a plurality of sound measuring devices, near the sound device, accessing a sound policy associated with the sound device, the sound policy comprising a predetermined sound threshold, receiving, from the selected measuring device, a measured sound level for the sound device, determining if the measured sound level exceeds the predetermined threshold, and, in response to determining the measured sound level exceeds the predetermined threshold, issuing a command to the sound device to reduce intensity for the sound being output.

In some embodiments disclosed herein, a device may receive a sound, access other managed devices, identify the sound-generating device, access a loudness policy associated with the sound-generating device, determine a sound level of the sound-generating device, determine if the measured sound level exceeds a threshold from the loudness policy, and issue a command to the sound-generating device to reduce the volume (e.g., directly or via a management server). In some embodiments, other managed devices may be discovered on the network via SSDP and/or communication with a management server.

In some embodiments, matching may be performed by matching an audio fingerprint of the captured sound to metadata of the content, as communicated with management server. For instance, some applications and platforms may be able to identify content, such as a song or film, by capturing audio and matching an audio fingerprint in a database, e.g., Shazam® and/or Gracenote®.

In some embodiments, a SDM engine may need to identify a sound-generating device on a network of managed devices. For instance, a device and/or management server may receive a sound input, generate an input fingerprint of the sound input, access managed devices, access fingerprints for device sounds generated by the managed devices, compare the input fingerprint to fingerprints for device sounds, determine if a fingerprint for any device sounds matches the input fingerprint, and provide the managed device associated with the matching fingerprint as an identified device.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative system of measuring sound levels and adjusting device volume, in accordance with some embodiments of the disclosure;

FIG. 2 depicts an illustrative system of measuring sound levels and adjusting device volume, in accordance with some embodiments of the disclosure;

FIG. 3A depicts an illustrative interface for managing sound level policies, in accordance with some embodiments of the disclosure;

FIG. 3B depicts illustrative data structures for managing sound level policies and devices, in accordance with some embodiments of the disclosure;

FIG. 4 depicts an illustrative sequence diagram of a process for managing sound levels, in accordance with some embodiments of the disclosure;

FIG. 5A depicts an illustrative flow diagram of a process for managing sound levels, in accordance with some embodiments of the disclosure;

FIG. 5B depicts an illustrative flow diagram of a process for managing sound levels, in accordance with some embodiments of the disclosure;

FIG. 5C depicts an illustrative flow diagram of a process for identifying a sound-generating device, in accordance with some embodiments of the disclosure;

FIG. 6 is a diagram of illustrative devices, in accordance with some embodiments of the disclosure; and

FIG. 7 is a diagram of an illustrative system, in accordance with some embodiments of the disclosure.

### DETAILED DESCRIPTION

Devices may be designed to facilitate content consumption. Content like video, animation, music, audiobooks, ebooks, playlists, podcasts, images, slideshows, games, text, and other media may be consumed by users at any time, as well as nearly in any place. Abilities of devices to provide content to a content consumer are often enhanced with the utilization of advanced hardware with increased memory and fast processors in devices. Devices—e.g., computers, telephones, smartphones, tablets, smartwatches, microphones (e.g., with a virtual assistant), activity trackers, e-readers, voice-controlled devices, servers, televisions, digital content systems, video game consoles, security systems, cameras, hubs, routers, modems, and other internet-enabled appliances—can provide and/or deliver content almost instantly.

The household devices may generally be any network-connected devices in a home or an environment near one or more media-viewing locations, such as a house, apartment/condo building, office, dormitory, hotel, school, community living arrangement, or other location. The network-connected devices may be Internet of Things (“IoT”) devices which are capable of communicating between the devices and a controller such as a virtual assistant platform, for example, Google® Home, Apple® Homepod, Amazon® Echo, as well as other home assistants and/or hubs. Such household devices and controllers may share some functions and may be able to communicate with content delivery devices via one or more networks.

Sound levels are typically determined by a sound level meter (SLM), also referred to as a decibel meter and/or a noise dosimeter (e.g., when used to monitor for dangerous noise levels over a period of time). Sound pressure—also referred to as sound intensity or sound power—may be measured in decibels (dB). The decibel scale is logarithmic, e.g., if a sound is 80 decibels, and another 10 decibels are added, the sound will be ten times more intense, and will seem about twice as loud to human ears. Some embodiments may use different weighting of the decibel scale based on frequency of tones such as, e.g., A-weighting, B-weighting, or C-weighting, which may better identify sound levels, frequencies, and durations that may be harmful to hearing. Likewise, other measurements of sound level, sound pressure, and/or sound energy make take the place (or supplement) embodiments disclosed as using decibels.

To determine or measure sound levels, an SLM generally uses a microphone with a known microphone sensitivity, e.g., a known voltage value produced when a constant sound pressure is applied. Using the known sensitivity of the particular microphone being used, the SLM is able to accurately convert a captured electrical signal back to sound pressure and display the resulting sound pressure level in decibels.

Applications on computers and smartphones may be able to capture audio and calculate a sound level measurement in decibels. One application from the National Institute for Occupational Safety and Health (NIOSH) is the NIOSH Sound Level Meter (SLM) app for iPhone, which was developed to help workers make informed decisions about their noise environment and promote better hearing health and prevention efforts. Using a mobile device's built-in microphone (or an external microphone), apps like the NIOSH SLM app may measure occupational noise exposure in a similar way to how professional measuring instruments do. Professional sound level meters must comply with national and international standards such as the American National Standards Institute (ANSI) S1.4-2014) and Specifications for Sound Level Meters and International Electrotechnical Commission (IEC) 61672. ANSI/IEC standards specify acoustical, electrical, and environmental tests with indicated tolerance limits and measurement uncertainties that are specified in decibels over a wide frequency range (e.g., typically from 10 Hz-20 kHz). SLM applications may output the sound level in different weighted decibels, including A-weighted decibels (“dBA”).

Generally, many devices discussed herein may comprise a microphone suitable for capturing sound and hardware configurable to measure sound level. The NIOSH SLM app is reported to work consistently with iPhones but, because several manufacturers make Android phones, there tends to be variance among same app measurements on difference devices. Likewise, smart devices with microphones and circuitry, such as televisions, tablets, virtual assistant devices, remote controls, etc., may be individually configured to function as sound level meters based on their respective microphone sensitivity. In some cases, an approximate reading may be acceptable. In some embodiments, sound profiles and/or calibration may be necessary. In some embodiments, sounds may be captured at a device, sound data communicated to a server, and the server may calculate the sound level based on the sound data and known microphone sensitivity of the device.

Many devices described herein may generate noise. In some cases, home appliances like washing machines, dryers, dish washers, refrigerators, air conditioners, heaters, garage door openers, cars, etc. may perform functions of connected devices. For instance, an oven's temperature may be configurable via a smartphone application, a refrigerator may feature a dynamic display screen with a family calendar, and/or a dryer can trigger a notification when a load is complete. Operations of such devices may be managed by a smart device management application, or a smart device management application in conjunction with a virtual assistant platform.

Smart device management (SDM) applications may take various forms such as operating systems, applications, control panel interfaces, etc. In some embodiments, SDM applications may be a part of or work in conjunction with interactive content guidance applications such as interactive television program guides, electronic program guides and/or user interfaces, which may allow users to navigate among and locate many types of content including conventional television programming (provided via broadcast, cable, fiber optics, satellite, internet (IPTV), or other means) and recorded programs (e.g., DVRs) as well as pay-per-view programs, on-demand programs (e.g., video-on-demand systems), internet content (e.g., streaming media, downloadable content, webcasts, shared social media content, etc.), music, audiobooks, websites, animations, podcasts, (video) blogs, ebooks, and/or other types of media and content. SDM and/or interactive guidance applications may comprise an internet browser, or web browser functions, to facilitate and track content access via the internet.

In some embodiments, SDM applications may be provided as a stand-alone application, an operating system, online application (e.g., provided via a website) performed on a computer, tablet, smartphone, or other mobile devices. An SDM application may facilitate access to content available through a television, or through one or more devices, or bring together content available both through a television and through internet-connected devices using interactive guidance. Various devices and platforms that may implement SDM applications are described in more detail below. In some embodiments, an SDM application may be referred to as an SDM engine and/or running on an SDM engine.

Devices, content delivery systems, SDM applications, and interactive content guidance applications may utilize input from various sources including remote controls, keyboards, microphones, video and motion capture, touchscreens, and others. For instance, a remote control may use a Bluetooth connection to a television or set-top box to transmit signals and/or to move a cursor. In some embodiments, devices, platforms, and applications may utilize input received via network commands. For instance, using External Control Protocol (ECP), a media device may be controlled over a network (e.g., a LAN) by providing a number of external control services. Such devices offering external control services may be discoverable using SSDP (Simple Service Discovery Protocol) as part of Internet Engineering Task Force (IETF) standard network protocols. ECP commands may be considered an API that may be accessed by programs in virtually any programming environment. ECPs may mimic functions of a remote control or other input device, such as “channel up,” “channel down,” and/or play/pause, but delivered via network. In some embodiments disclosed herein, communication of ECPs may allow control of a device's volume and/or loudness via network-transmitted control commands, “volume up,” “volume down,” and “mute,” if necessary. In some embodiments, volume may be set as a percentage (e.g., 65%) or as a rating on a scale such as a “level 6” on a scale of 0 to 10.

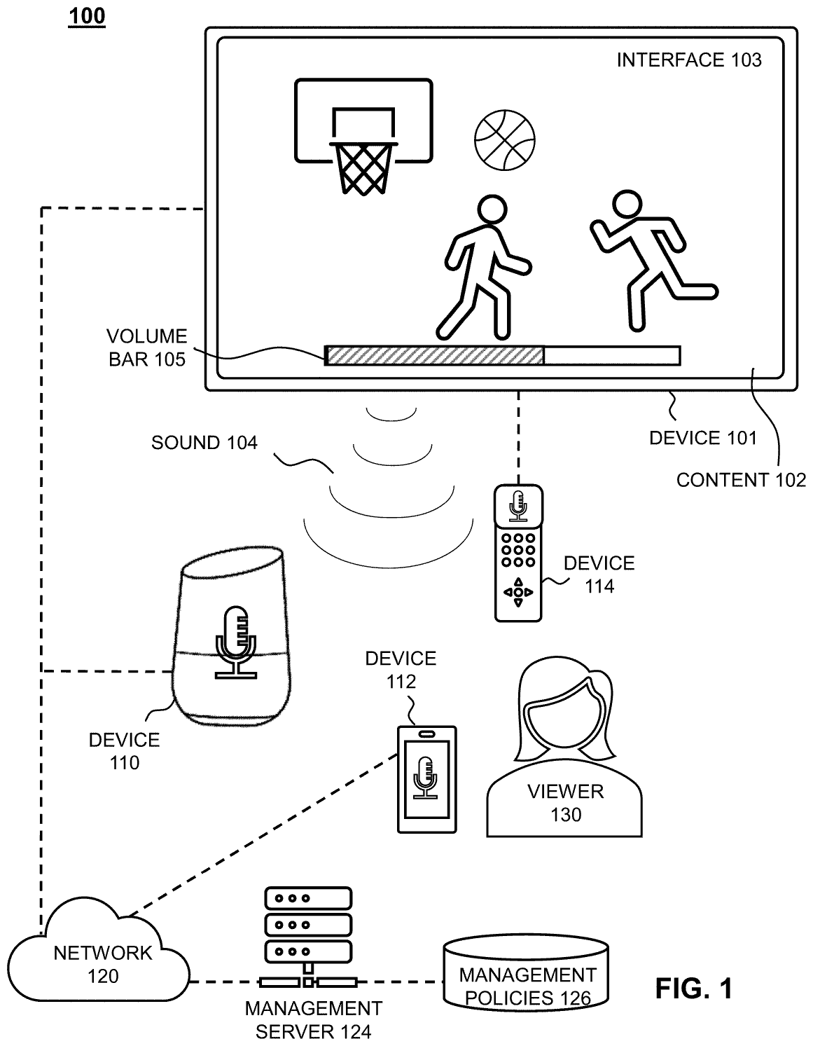

FIG. 1 depicts an illustrative system of measuring sound levels and adjusting device volume, in accordance with some embodiments of the disclosure. Scenario 100 of FIG. 1 illustrates multiple connected devices in a system managed by a smart device management (SDM) engine. Scenario 100 of FIG. 1 also illustrates an interactive content guidance application interface, interface 103, providing content 102.

In scenario 100, interface 103 is presented on a screen of device 101, generating sound 104. By way of a non-limiting example, scenario 100 depicts device 110, device 112, and device 114 capturing sound 104 in order to measure loudness so that an SDM engine may control the sound generated by device 101, e.g., if too loud. For instance, one or more of device 110, device 112, and device 114 may capture sound 104 and relay a sound level measurement to management server 124, which may transmit a command to device 101 to lower the volume.

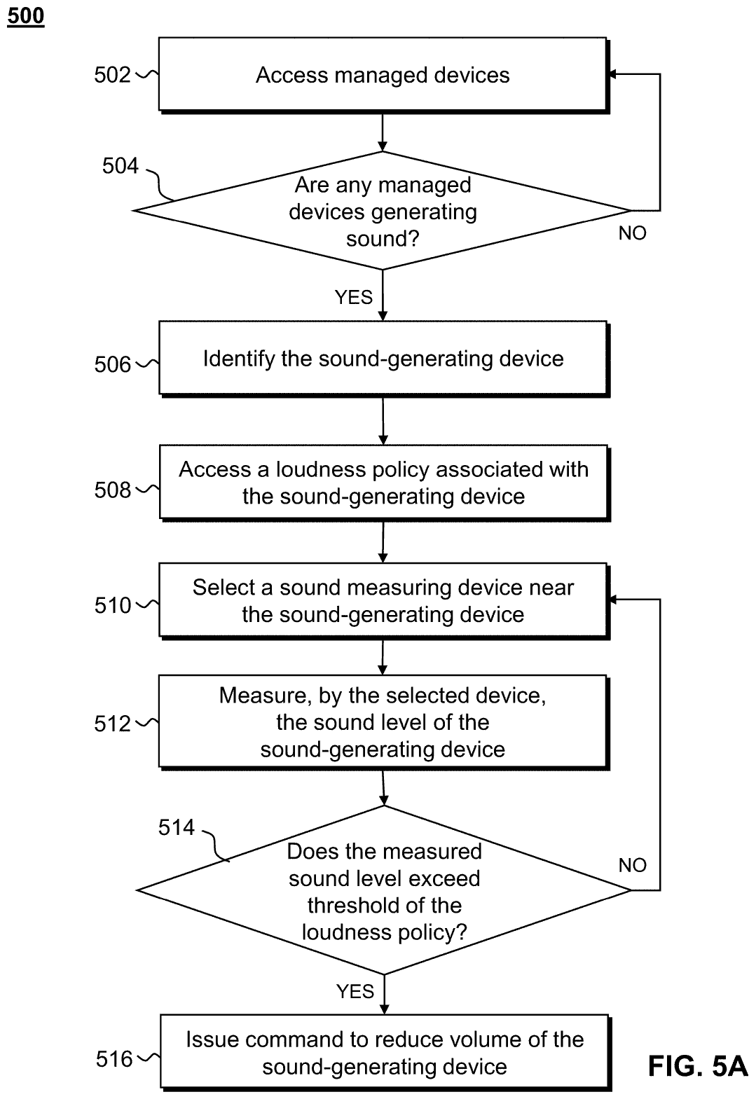

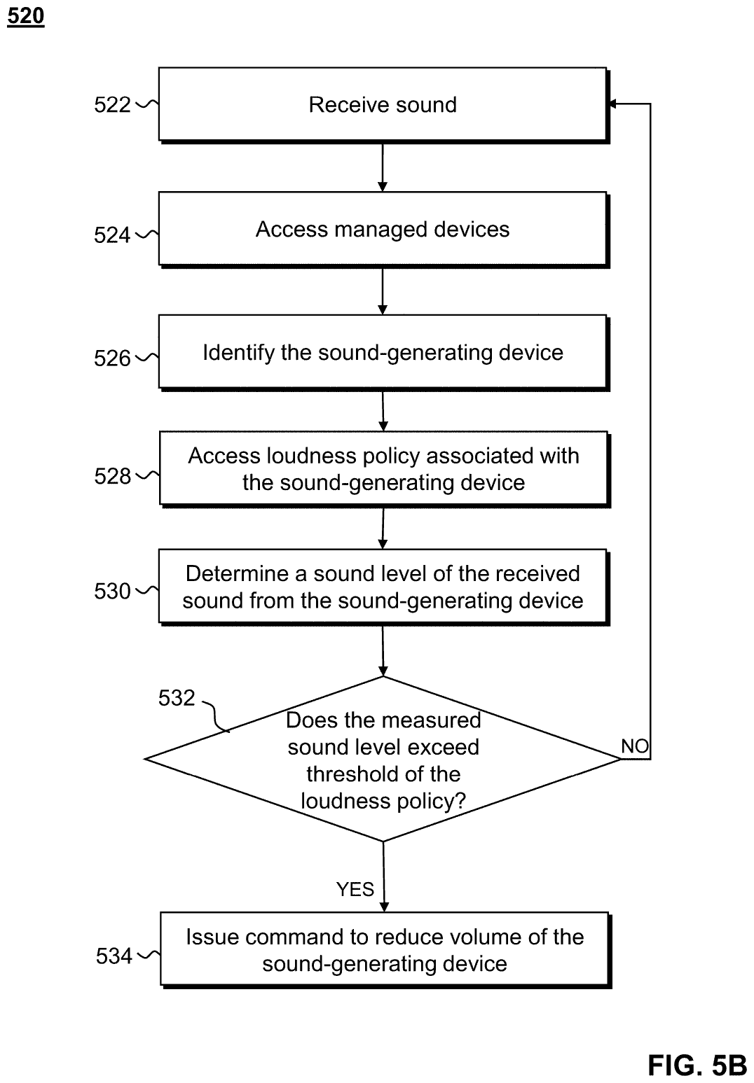

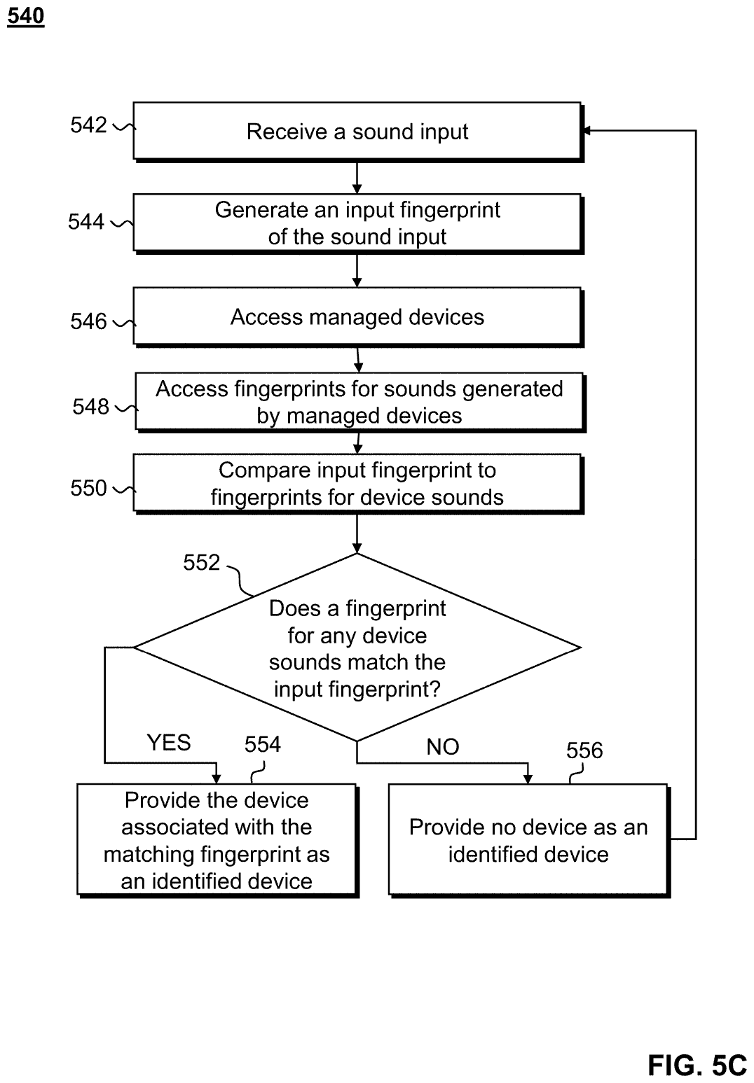

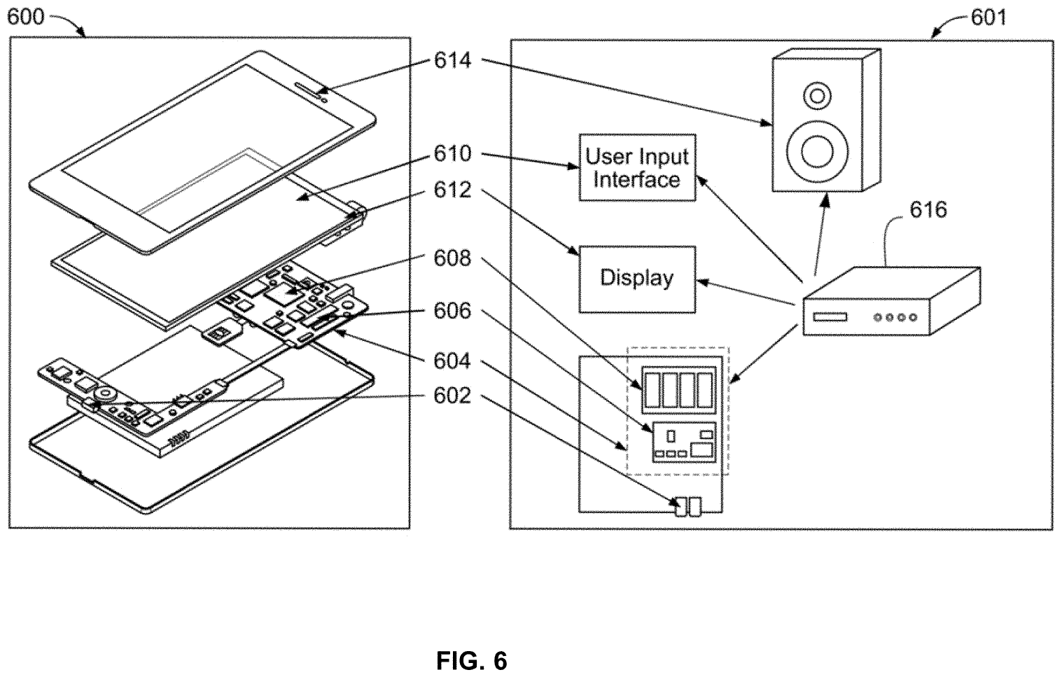

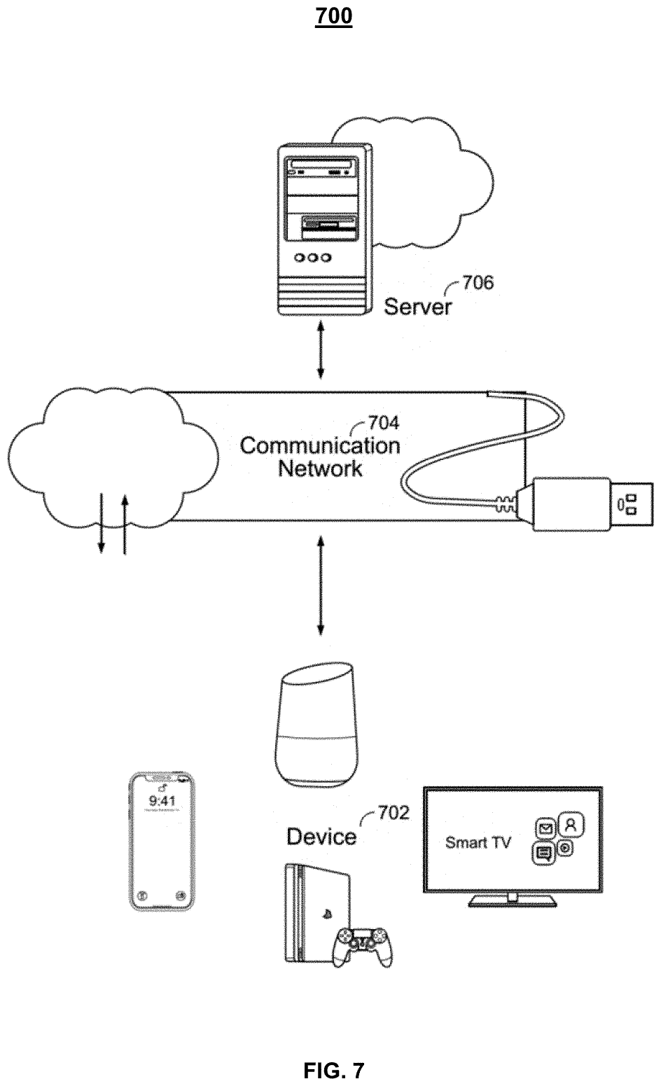

Exemplary processes for managing sound levels are described in FIGS. 5A-C and may be carried out by a SDM engine, e.g., as part of a content delivery platform or interactive content guidance application, stored and executed by one or more of the processors and memory of a device and/or server such as devices 101, 110, 112, and 114, management server 124, and devices depicted in FIGS. 6 and 7. In some embodiments, management server 124 may comprise a SDM engine or function as a SDM engine. In some embodiments, interface 103 may be a part of the SDM engine or work in conjunction with a SDM engine.

Scenario 100 depicts providing content 102, with sound 104, by interface 103 for consumption via device 101. Device 101 may be, for instance, a television, set-top box, streaming device, computer, smartphone, tablet, or other device able to access a content delivery network that provides interface 103 and content 102. Interface 103 may be a part of a content delivery platform or interactive content guidance application, stored and executed by one or more of the processors and memory of a device and/or server such as those depicted in FIGS. 6 and 7. Content 102 may be delivered via a content delivery system using one or more of cable, fiber, satellite, antenna, streaming over IP, wireless, or other content delivery methods. Content 102 may be captured live for live broadcast and/or streaming. For instance, content 102 may be a basketball game available via, e.g., streaming or cable. Interface 103 may display a volume bar, e.g., volume bar 105, in the lower portion of the screen to illustrate to viewers the adjustable volume level for the sound portion of content 102. In scenario 100, device 101 may produce sound or be connected to speakers used to produce sound, e.g., depicted in FIG. 6. In some embodiments, device 101 may be an audio-only device and content 102 may be audio only (or an audio portion of multimedia content).

In scenario 100, each of device 110, device 112, and device 114 may comprise a microphone, e.g., able to capture sound 104. In some embodiments, a microphone may be attached to or connected with each of device 110, device 112, and device 114. In some embodiments, a microphone may be connected via network to at least one of device 110, device 112, and device 114. In scenario 100, device 110 is depicted to be, e.g., a smart speaker with a virtual assistant; device 112 is depicted as a smartphone (e.g., with a virtual assistant), and device 114 is depicted as a voice-enabled remote control (e.g., connected to device 101 wirelessly). In some embodiments, one or more of device 110, device 112, and device 114, along with device 101, may be connected to network 120, e.g., a local area network (LAN) connected to the internet. For instance, device 110 may connect to network 120 via ethernet and/or WiFi (IEEE 802.11x), device 112 may be connected to network 120 via WiFi or connected to the internet via 4G/LTE or 5G cellular network(s), and device 114 may be connect via Bluetooth to device 101, which may be connected to network 120 via WiFi or ethernet. In some embodiments, network 120 may be a wide area network (WAN) or a LAN.

Also connected to network 120, in scenario 100, is management server 124 and management policy database 126. Management server 124 may be running at least a portion of an SDM engine and/or SDM application. In some embodiments, management server 124 may request loudness measurements, access sound level policies from management policy database 126, compare loudness measurements to thresholds from sound level policies, and issue commands to control playback of sound and/or device volume. In some embodiments, such commands may be transmitted and received as ECP commands. For instance, management server 124 may send an ECP command via network 120 instructing interface 103 of device 101 to reduce the volume of content 102 as it is played. FIGS. 5A-B describe processes for issuing a command when a sound is determined to be too loud. Generally, at least one of devices 110-114 may capture sound 104, generate a sound level measurement, transmit sound data via network to management server 124, which may access profiles in sound management policies database 126, compare the received sound data to a threshold, and, if the threshold is exceeded, send an ECP control signal for interface 103 of device 101 to lower the volume of content 102.

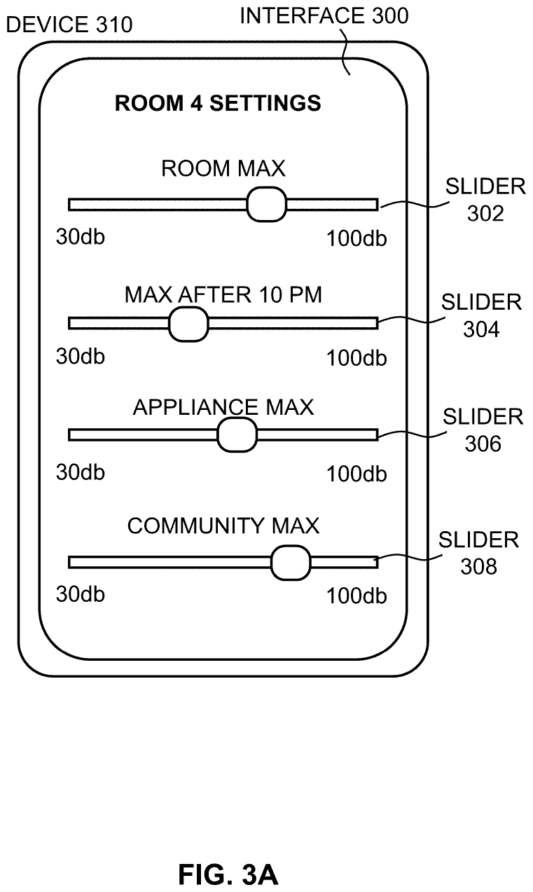

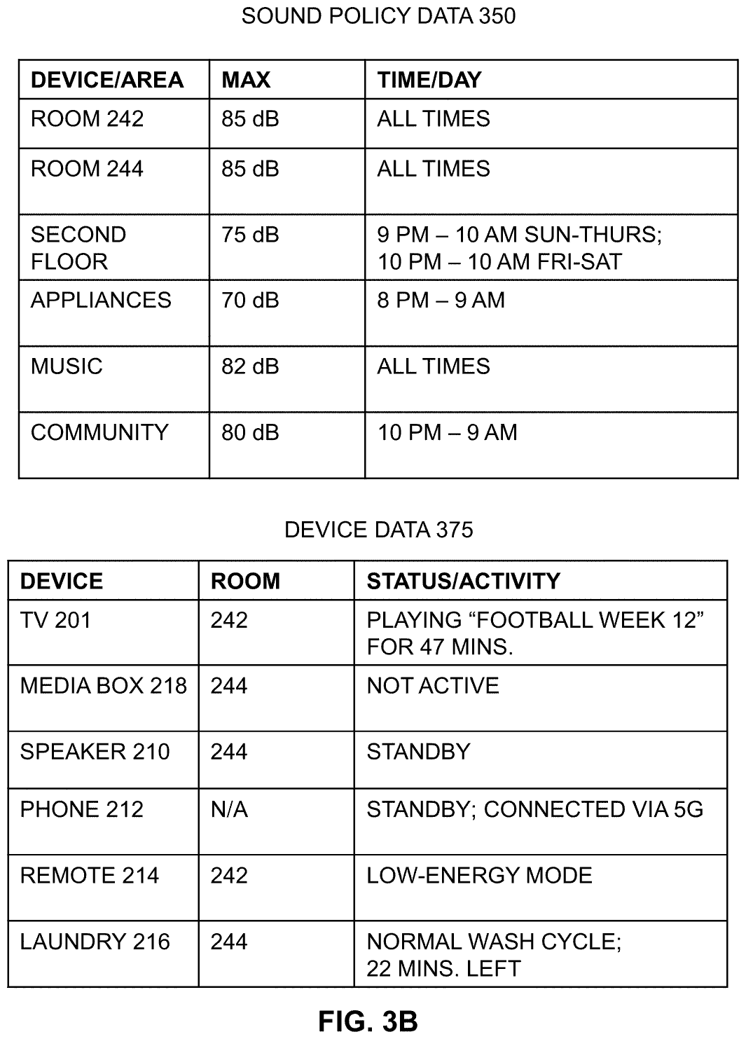

Management server 124 may be in communication with sound management policies database 126 via network 120 or another network. Sound management policies database 126 may store sound level policies and thresholds for sound level limits for a home, building, community, etc. For instance, sound management policies database 126 may store a profile for each device on a network comprising a sound level limit for the specific device. In some embodiments, sound management policies database 126 may store sound profiles for specific rooms, floors, apartments, dwellings, offices, or other communities and/or sub-communities. For instance, sound management policies database 126 may store a profile for one or more children's rooms in a house to limit the streaming music noise levels to be below a certain sound level, e.g., 65 dB, after 8 p.m. Sound management policies database 126 may store a profile for the fifth floor of a hotel that requires television noise levels to be below a certain sound level, e.g., 55 dB, after 10 p.m., while storing another profile that permits noise levels up to 70 dB on the penthouse floor. Sound management policies database 126 may store a profile only permitting noise above 80 dB during the hours of noon until 4 p.m. Management server 124 may configure policies saved in sound management policies database 126, e.g., via setting set in an SDM application. For instance, an SDM application may allow setting of one or more sound level thresholds, associated times, and associated devices/locations. FIG. 3A depicts an interface for setting of sound level thresholds for one or more sound management policies.

In some embodiments, management server 124 may access managed devices on network 120 (e.g., device 101, device 110, device 112, and device 114), determine if any managed devices are generating sound (e.g., sound 104 from device 101), identify the device, access a loudness policy (from, e.g., management policies database 126) associated with the sound-generating device (e.g., device 101), select a sound measuring device (e.g., device 110, device 112, and device 114) near the sound-generating device (e.g., device 101), receive a measured sound level of the sound-generating device, determine if the measured sound level exceeds a threshold from the loudness policy, and issue a command to the sound-generating device to reduce the volume. FIG. 5A describes a procedure for issuing a command when sound level is measured to be above a threshold.

In some embodiments, a device, such as device 112 (or device 110, device 114) may receive a sound, access other managed devices on network 120 (e.g., device 101, device 112, and device 114) via communication with management server 124, identify the sound-generating device as device 101 (e.g., by matching an audio fingerprint of the captured sound to metadata of the content, as communicated with management server 124), access a loudness policy (from, e.g., management policies database 126 via management server 124) associated with the sound-generating device (e.g., device 101), determine a sound level of the sound-generating device, determine if the measured sound level exceeds a threshold from the loudness policy, and issue a command to the sound-generating device to reduce the volume (e.g., directly or via communication with management server 124). FIG. 5B describes a procedure for issuing a command when sound level is measured to be above a threshold.

In some embodiments, a SDM engine may need to identify a sound-generating device on a network of managed devices. For instance, a device (e.g., device 110) and/or management server (e.g., management server 124) may receive a sound input (e.g., sound 104), generate an input fingerprint of the sound input, access managed devices on network 120 (e.g., device 101, device 112, and device 114), access fingerprints for sounds generated by the managed devices on the network (e.g., a fingerprint associated with content 102 played on device 101), compare the input fingerprint to fingerprints for device sounds, determine if a fingerprint for any device sounds matches the input fingerprint, and provide the managed device (e.g., device 101) associated with the matching fingerprint as an identified device. FIG. 5C describes a procedure for identifying a sound-generating device on a network by using an audio fingerprint.

In some embodiments, multiple devices may measure sound level. In scenario 100, one or more of device 110, device 112, and device 114 may capture audio for sound level measurement. Each of device 110, device 112, and device 114 may function as a sound level meter and/or incorporate an SLM application to produce a sound level reading. In some embodiments, sound may be captured for predetermined lengths of time, at predetermined intervals. For example, device 110 may capture audio at an interval of, e.g., every 30 seconds, to measure sound level and allow a comparison to a loudness policy threshold. The duration of audio captured may need only to be a second or a fraction of a second, e.g., 35-125 milliseconds. In some cases, multiple seconds or multiple captures over a few seconds may be taken and the peak loudness may be used as the measurement. In some embodiments, a connected microphone device, such as device 110, device 112, and device 114, may capture audio and measure loudness at the device. In some embodiments, a connected microphone device may transmit the captured sound as an audio file (e.g., .wav, .mp3, .m4a, etc.) for processing and/or measurement at another device or at a management server.

Some devices may capture audio more or less frequently, or at variable frequencies. For instance, some devices may capture audio more frequently at certain times of the day (e.g., night hours, after 9 p.m.). In some embodiments, one or more of device 110, device 112, and device 114 may capture sounds based on a request, e.g., from management server 124. In some embodiments, a device may capture sounds at a regularity based on a level of battery power and/or whether the device is plugged in to power. For instance, a virtual assistant device such as device 110 is depicted to be, may be able to sample more frequently if it is plugged in than, e.g., a smartphone (device 112) which must be charged regularly or a AA battery-powered remote control (device 114). Likewise, the type of connection, e.g., WiFi or Bluetooth, and the required energy to transmit a sample, may dictate the frequency of capture. In some embodiments, a device with a microphone may capture sounds more frequently based on a determination that a prior sound level measurement was close to a policy threshold. For example, if a reading is just under a threshold, or if two or more measurements demonstrate a sound level increasing towards the threshold, captures may become more frequent. Plotting sound level measurements by a microphone device versus time as a graph or chart may generate a rate of change of loudness, which may indicate a need to capture more frequently, e.g., because loudness is increasing rapidly and may exceed the threshold quickly. In some embodiments, a trained model may be used to identify whether changing sound measurements might lead to exceeding a threshold.

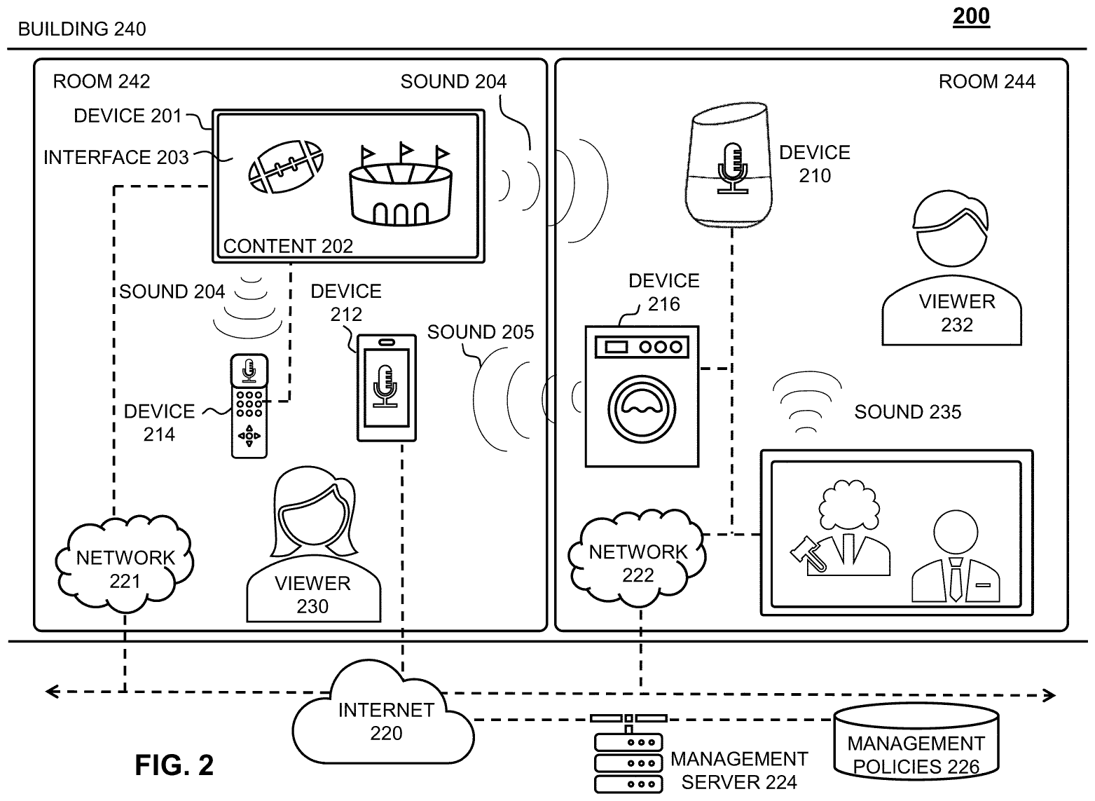

FIG. 2 depicts an illustrative system of measuring sound levels and adjusting device volume, in accordance with some embodiments of the disclosure. Scenario 200 of FIG. 2 illustrates multiple connected devices in at least two rooms in a system managed by a smart device management (SDM) engine. Scenario 200 of FIG. 2 also illustrates an interactive content guidance application interface, interface 203, providing content 202.

In scenario 200, interface 203 is presented on a screen of device 201, generating sound 204. By way of a non-limiting example, scenario 200 depicts device 210, device 212, and device 214 capturing sound 204 in order to measure loudness so that an SDM engine may control the sound generated by device 201, e.g., if too loud. For instance, one or more of device 210, device 212, and device 214 may capture sound 204 and relay a sound level measurement to management server 224, which may transmit a command to device 201 to lower the volume. In scenario 200, at least device 210 is in one room, room 244, and configured to measure sound level of sound-generating devices (e.g., device 201) in another room, room 242.

Exemplary processes for managing sound levels are described in FIGS. 5A-C and may be carried out by a SDM engine, e.g., as part of a content delivery platform or interactive content guidance application, stored and executed by one or more of the processors and memory of a device and/or server such as devices 201, 210, 212, and 214, management server 224, and devices depicted in FIGS. 6 and 7. In some embodiments, management server 224 may comprise a SDM engine or function as a SDM engine. In some embodiments, interface 203 may be a part of the SDM engine or work in conjunction with a SDM engine.

Scenario 200 depicts providing content 202, with sound 204, by interface 203 for consumption via device 201. Device 201 may be, for instance, a television, set-top box, streaming device, computer, smartphone, tablet, or other device able to access a content delivery network that provides interface 203 and content 202. In some embodiments, device 201 may be an audio-only device and content 202 may be audio only (or an audio portion of multimedia content).

In some embodiments, such as depicted in scenario 200, a connected device, such as device 216, may generate sound that is not necessarily from playback of content. For instance, device 216 may be considered a network-connected household appliance such as a washing machine, dryer, dish washer, air conditioner, heater, etc. Device 216 may generate sound at various levels, e.g., during different cycles and processes. Such an appliance may be configured to receive control commands, e.g., as part of an IoT infrastructure, to pause cycles and/or switch to a lower sound mode that may take longer (e.g., quiet mode, delicate mode, etc.). Like sound 204 generated by device 101, sound 205 generated by device 216 may be considered a nuisance and may be detected as too loud. For instance, sound 205 is generated by device 216 in room 244 but may be detected and measured by device 212 in room 242.

In scenario 200, each of device 210, device 212, and device 214 may comprise a microphone, e.g., able to capture sound 204 and//or sound 205. In some embodiments, a microphone may be attached to or connected with each of device 210, device 212, and device 214. In some embodiments, a microphone may be connected via network to at least one of device 210, device 212, and device 214. In scenario 200, device 210 is depicted to be, e.g., a smart speaker with a virtual assistant; device 212 is depicted as a smartphone (e.g., with a virtual assistant), and device 214 is depicted as a voice-enabled remote control (e.g., connected to device 201 wirelessly). In scenario 200, device 210 (e.g., a smart speaker) is depicted as connected to network 222 in room 244, device 212 (e.g., a smartphone) is depicted to be directly connected to internet 220, device 214 is depicted as connected to device 201 wirelessly (e.g., a Bluetooth connection between a television and a remote), and device 201 is connected to network 221 in room 242. In some embodiments, network 221 and network 222 may each be considered a LAN or WAN. In some embodiments, network 221 and network 222 may have communication access, be one network, and/or be linked via internet 220 with management server 224.

Also connected to networks 221 and 222, in scenario 200, is management server 224 and management policy database 226, e.g., via internet 220. Internet 220 may be considered to be, e.g., the internet, a LAN, a WAN, a private network, a virtual network, or some other network. Management server 224 may be running at least a portion of an SDM engine and/or SDM application. In some embodiments, management server 224 may request loudness measurements, access sound level policies from management policy database 226, compare loudness measurements to thresholds from sound level policies, and issue commands to control playback of sound and/or device volume. In some embodiments, such commands may be transmitted and received as ECP commands. For instance, management server 224 may send an ECP command via internet 220, and network 221, instructing interface 203 of device 201 to reduce the volume of content 202 as it is played. FIGS. 5A-B describe processes for issuing a command when a sound is determined to be too loud. Generally, at least one of devices 210-114 may capture sound 204, generate a sound level measurement, transmit sound data via network/internet to management server 224, which may access profiles in sound management policies database 226, compare the received sound data to a threshold, and, if the threshold is exceeded, send an ECP control signal for interface 203 of device 201 to lower the volume of content 202.

Management server 224 may be in communication with sound management policies database 226 via internet 220 or another network. Sound management policies database 226 may store sound level policies and thresholds for sound level limits for a home, building, community, etc. For instance, sound management policies database 226 may store a profile for each device on a network comprising a sound level limit for the specific device. In some embodiments, sound management policies database 226 may store sound profiles for specific rooms, floors, apartments, dwellings, offices, or other communities and/or sub-communities. For instance, sound management policies database 226 may store a profile for room 242 to limit the television sound levels to be below a certain sound level, e.g., 72 dB, after 11 p.m. Sound management policies database 226 may store a profile for the second floor of an apartment building (or hotel) that requires streaming music to be below a certain sound level, e.g., 65 dB, after 8 p.m. Sunday through Thursday, while storing another profile that permits noise levels up to 78 dB on Fridays and Saturdays. Sound management policies database 226 may store a profile only permitting noise above 82 dB during the hours of 11 a.m. until 2 p.m. Management server 224 may configure policies saved in sound management policies database 226, e.g., via setting set in an SDM application. For instance, an SDM application may allow setting of one or more sound level thresholds, associated times, and associated devices/locations. FIG. 3A depicts an interface for setting of sound level thresholds for one or more sound management policies.

In some embodiments, management server 224 may access managed devices on networks 221 and 222 (e.g., device 201, device 210, device 212, device 214, and device 216), determine if any managed devices are generating sound (e.g., sound 204 from device 201), identify at least one device, access a loudness policy (from, e.g., management policies database 226) associated with the sound-generating device (e.g., device 201), select a sound measuring device (e.g., device 210, device 212, and device 214) near the sound-generating device regardless of which room each is in, receive a measured sound level of the sound-generating device, determine if the measured sound level exceeds a threshold from the loudness policy, and issue a command to the sound-generating device (e.g., device 201) to reduce the volume. FIG. 5A describes a procedure for issuing a command when sound level is measured to be above a threshold.

In some embodiments, management server 224 may access managed devices on networks 221 and 222 (e.g., device 201, device 210, device 212, device 214, and device 216), determine if, e.g., there is an active sound-generating connected-appliance like device 216, identify the device (e.g., device 216 as a washing machine per IoT communications), access a loudness policy (from, e.g., management policies database 226) associated with the sound-generating device (e.g., device 216), select a sound measuring device (e.g., device 212) near the sound-generating device regardless of which room each is in, receive a measured sound level of the sound-generating device (e.g., device 212 transmits a sound level of sound 205), determine if the measured sound level exceeds a threshold from the loudness policy, and issue a command to the sound-generating device to reduce the volume. Some embodiments, for example, may determine that a policy requires no appliances run in modes louder than 75 dB after 8 p.m. on the second floor (or in an apartment building), so that a sound level measurement of 77 dB of sound 205 from device 216 by device 212 may trigger a command sent (via management server 224) to device 216 to change to a quitter mode, e.g., a delicate or low-power mode. In some embodiments, device 216 may be verified—by sound matching and/or network communication—as the actual generator of sound 205. FIG. 5C describes an exemplary procedure for identifying a sound-generating device on a network by using an audio fingerprint.

In some embodiments, a device, such as device 210 may receive a sound (e.g., sound 204 from room 242), access other managed devices on networks 220, 221, 222 (e.g., device 201, device 214, device 216) via communication with management server 224, identify the sound-generating device as device 201 (e.g., as described in FIG. 5C), access a loudness policy (from, e.g., management policies database 226 via management server 224) associated with the sound-generating device (e.g., device 201), determine a sound level of the sound-generating device, determine if the measured sound level exceeds a threshold from the loudness policy, and issue a command to the sound-generating device to reduce the volume (e.g., directly or via communication with management server 224). FIG. 5B describes a procedure for issuing a command when sound level is measured to be above a threshold.

In some embodiments, a device, such as device 212 may receive a sound (e.g., sound 205 from room 244), access other managed devices on networks 220, 221, 222 (e.g., device 201, device 214, device 216) via communication with management server 224, identify the sound-generating device as device 216 (e.g., via IoT communication), access a loudness policy (from, e.g., management policies database 226 via management server 224) associated with the sound-generating device (e.g., device 216), determine a sound level of the sound-generating device, determine if the measured sound level exceeds a threshold from the loudness policy, and issue a command to the sound-generating device to reduce the volume (e.g., directly or via communication with management server 224).

FIG. 3A depicts an illustrative interface for managing sound level policies, in accordance with some embodiments of the disclosure. FIG. 3A depicts interface 300 of device 310 featuring slider bars on a scale of 30 dB to 100 dB. For instance, “Room 4 Settings” in interface 300 comprises slider 302 for the “room max,” slider 304 for the “max after 10 p.m.,” slider 306 for the “appliance max,” and slider 308 for the “community max.”

Interface 300 may comprise a settings menu or application for a SDM platform. In some embodiments, interface 300 may be used by an administrator of the SDM platform. For instance, a hotel manager may set sound level policies for guest rooms, a parent might set policies for a family, and a superintendent or condo association board might set policies for a building. Some embodiments may require an administrator login to access interface 300.

Interface 300 depicts, for example, a room maximum of about 75 dB, a maximum after 10 p.m. of 60 dB, an appliance maximum of 70 dB, and a community maximum of 80 dB. Each of sliders 302 to 208 may be adjusted to preferred limits. In some embodiments, additional times and days may be specified. In some embodiments, additional slider bars and settings may be added.

FIG. 3B depicts illustrative data structures for managing sound level policies and devices, in accordance with some embodiments of the disclosure. For instance, FIG. 3B depicts illustrative data structures sound policy data 350 and device data 375. Each of policy data 350 and device data 375 may be stored at (or accessible via) a management server and/or policy database such as management server 124, management server 224, sound management policy database 126, and/or sound management policy database 226.

Policy data 350 comprises data describing sound level limitations for devices, areas, types of sounds, etc. For instance, each device, area, and/or other classification of device or content may have a maximum sound limit for a specified time and/or day. For example, according to sound policy 350, room 242 has a limit of 85 dB at all times, room 244 also has a limit of 85 dB at all times, the second floor has a limit of 75 dB from 9 p.m. to 10 a.m. Sunday through Thursday and 10 p.m. through 10 a.m. from Friday through Saturday. In some embodiments, such as the policies depicted in sound policy data 350, for example, there may be a limit on appliances have a limit of 70 dB from 8 p.m. to 9 a.m. In some embodiments, such as the policies depicted in sound policy data 350, for example, all music played in the building/community may have a limit of 82 dB at all times. In some cases, a community may have a limit of 80 dB from 10 p.m. to 9 a.m. every night. In some embodiments, policy data may be accessed via a device management interface, e.g., as depicted in FIG. 3A. Policy data 350 may be stored in one or more databases, such as sound management policies database 126 of FIG. 1. and/or sound management policies database 226 of FIG. 2.

Device data 375 comprises data describing managed devices, e.g., connected the network and their current status. For instance, each device may have an assigned room (or scene) and a current status or activity. Device data 375, for example, describes that television 201 is in room 242 and playing “football week 12,” e.g., for the past 47 minutes, media box 218 is in room 244 and is not currently active, speaker 210 is in room 244 and is in standby mode, phone 212 is not assigned to any room (but it may be detected, in some embodiments), is connected via 5G, and is also in standby mode, remote 214 is in room 242 and is using low-energy mode, and laundry 216 is in room 244 and running a normal wash cycle with about 22 minutes left. In some embodiments, each device in device data 375 may have a recent sound level measurement recorded. For instance, television 201 may have been measured by speaker 210 to have a sound level of 68 dB or laundry 216 may have been measured by phone 212 to have a sound level of 71 dB. In some embodiments, device data may be updated regularly and/or on-demand when requested by another device on the network. In some embodiments, a management server (e.g., management servers 124 and/or 224) may access managed devices and request status updates. In some embodiments, each device updates its status regularly, e.g., every 1-2 minutes.

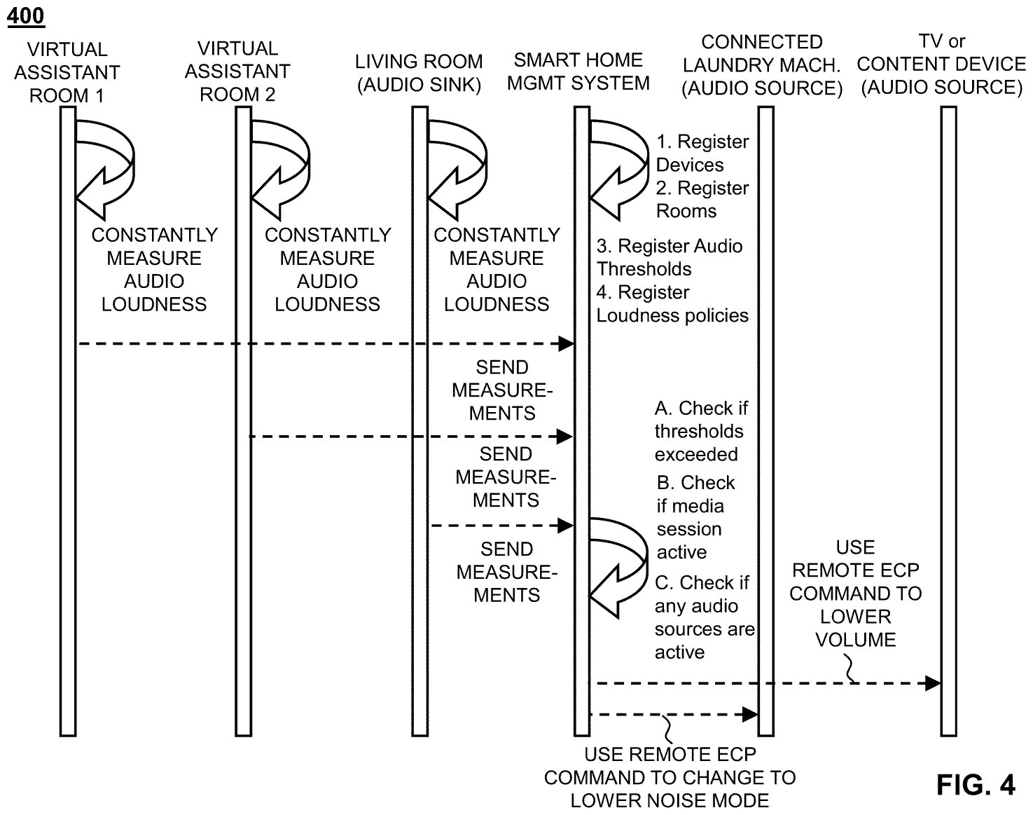

FIG. 4 depicts an illustrative sequence diagram of a process for managing sound levels, in accordance with some embodiments of the disclosure. In scenario 400, a smart device management (SDM) system will receive loudness level measurements from all the sound level measurement (e.g., audio sink) devices in the management network (e.g., home, building, community, etc.). The SDM system will have specific policies for each room, for instance for Bedrooms, sound level range could be just between 40 dB-55 dB at night (between 10 p.m. and 8 a.m.) whereas for a living room, a sound level range could be 40 dB and 80 dB. Such policies may also be set based on the day of week, weekends, holidays, sunrise, sunset, and other local and global calendar events. As the smart assistant devices are reporting loudness levels at a frequent occurrence (e.g., 200 ms), when an upper limit violation condition is detected, the SDM system will issue a “VolDown” command to one or more audio source devices that are active at the moment (and deemed to be causing the noise violation). For instance, if 50 dB is measured within Bedroom 1 at 11 p.m. and if the system determines that the living room TV media session is active at the moment, the SDM system will issue a “VolDown” message via ECP to the TV.

For any transient loudness occurrences that may surpass the sound level limit, such as audio intensity jump due to background music or ads that are present within the media stream, a decision to lower the volume can be made by the local device, e.g., the remote microphone that is in the same room as TV. Whenever a “VolDown” command is issued, the SDM system can remember the previous device volume level and adjust the volume back up to the original level after the original threshold violation condition is no longer valid (e.g., the overly loud commercial is over). This will minimize issues where the user tries handle the volume situation, which can be a nuisance.

Furthermore, any sound level measuring devices and/or audio sensors that are close to each other will report loudness measurements that the SDM system can deduce what sound is coming from what device. For instance, if a smart assistant in the living room is reporting 50 dB noise level and the microphone of the remote control is reporting 55 dB while the TV is on, it will be deduced that most of the loudness is due to the TV media session. Over time, the SDM system may build better accuracy with room-specific historical models that take into account the reflections and reverberations of audio waves within the same room, e.g., as reported by sensor devices within the same vicinity. Such a home-specific audio map will help the SDM system to make better determinations of when to issue the “VolDown” commands when the system makes an assessment that audio source and audio sensor are close to each other in terms of distance. In fact, the SDM system may group such audio sensors, audio sinks, and source devices together based on the particular topology of the room, home, or building. Moreover, the SDM system may add or suggest new audio loudness policies based on differing/changing context. If the SDM system detects many Wi-Fi strong signals and SSIDs advertised which are different than the WIFI service set identifier (SSID) that it is on, it will recommend a much tighter loudness threshold with a lower upper limit (say 60 dB rather than 70 dB upper limit) because that means this smart home is in a multi dwelling unit with neighbors/residents nearby. The SDM system may also instruct other audio sources such as a connected washing machine to pause or change to a quieter mode of operation. Other similar audio sources could be (e.g., Bluetooth) speakers, soundbars, etc. that the SDM system can control the loudness factor. Moreover, the SDM system may detect, e.g., via Wi-Fi sensing, that a human is lying down/sleeping in a particular room and may lower the sound level upper bound temporarily during that sleep cycle. In another embodiment of this invention, the SDM system may also aggregate the collected historical data over time and display to the user specific statistics about how much noise they were subject to per day, per room and per device, wherever data is available from smart assistant devices or other audio sensors reported to it.

FIG. 5A depicts an illustrative flow diagram of a process for managing sound levels, in accordance with some embodiments of the disclosure. There are many ways for issuing a command when sound level is measured to be above a threshold and process 500 of FIG. 5A is an exemplary method. For instance, a sound level may be measured and compared to a threshold stored in a sound level policy associated with the device generating the sound, and a command may be issued to the sound-generating device if the measured sound level exceeds the threshold.

Some embodiments may utilize a SDM engine to perform one or more parts of process 500, e.g., as part of a smart device management (SDM) application, smart home hub, content delivery platform, and/or interactive content guidance application, stored and executed by one or more of the processors and memory of a device and/or server such as those depicted in FIGS. 6 and 7. For instance, a SDM engine may run on a sound management server in communication with a network-connected device providing content and a network-connected device capable of measuring sound levels. At least a portion of a SDM engine may run on a component of a television, set-top box, computer, streaming device, smartphone, tablet, smart speaker, server, or other device able to communicate via a network.

At step 502, a SDM engine receives accesses managed devices communicating on a network. For instance, in scenario 100 of FIG. 1, management server 124 may access managed devices 101, 110, 112, and 114 on network 120. Generally, connected devices offering external control services may be discoverable using SSDP (Simple Service Discovery Protocol) as part of IETF standard network protocols and compatible APIs. In some embodiments, when accessing each device, a request to update status may be made so that data describing the device status and metadata describing any content being played by each device may be readily accessible.

At step 504, the SDM engine determines if any managed devices are generating sound. For example, in scenario 100 of FIG. 1, management server 124 may determine that sound 104 is provided by a device on the network (e.g., device 101, a television). If the SDM engine determines there are no managed devices generating sound, process 500 may start over, e.g., at the prescribed time or triggering action.

If, at step 504, the SDM engine determines there is at least one managed device generating sound then, at step 506, the SDM engine identifies the device that is generating sound. For example, in scenario 100 of FIG. 1, management server 124 may identify that device 101, e.g., a television, is producing that sound 104. In some embodiments, an SDM engine may determine a networked device is actively playing audio with a request and/or command. In some embodiments, a networked device that is actively playing audio may automatically inform the SDM engine when the device changes playback status and/or updates the playback status regularly (e.g., every 15-60 seconds). In some embodiments, a networked device that is actively playing audio may relay metadata of the content being played to the SDM engine.

At step 508, the SDM engine accesses a loudness policy associated with the identified sound-generating device. In some embodiments, a sound management policies database may store policies, profiles, and/or thresholds to be used for sound level limits of certain devices, in certain areas, and/or with particular content types. For instance, in scenario 100 of FIG. 1, management server 124 may access a loudness policy, from management policies database 126, that is associated with the identified sound-generating device: device 101. In some embodiments, for example, sound management policies database 126 may store a profile for one or more children's rooms in a house to limit the streaming music noise levels to be below a certain sound level, e.g., 65 dB, after 8 p.m. Sound management policies database 126 may store a profile for the fifth floor of a hotel that requires television noise levels to be below a certain sound level, e.g., 55 dB, after 10 p.m., while storing another profile that permits noise levels up to 70 dB on the penthouse floor.

Sound management policies database 126 may store a profile only permitting noise above 80 dB during the hours of noon until 4 p.m. Management server 124 may configure policies saved in sound management policies database 126, e.g., via setting set in an SDM application. For instance, an SDM application may allow setting of one or more sound level thresholds, associated times, and associated devices/locations. FIG. 3A depicts an interface for setting of sound level thresholds for one or more sound management policies.

At step 510, the SDM engine selects a sound measuring device near the sound-generating device. For instance, in scenario 100 of FIG. 1, management server 124 may select a sound measuring device such as device 110, device 112, or device 114 that is known to be near the sound-generating device, device 101. In some embodiments, certain devices with connected microphones may be known by the SDM engine as close in proximity to the sound-generating device based on device profile. For example, the voice-activated remote control for the television or cable box will likely be close to the television. In some cases, devices may belong to a smart home “group” or room, and proximity may be inferred for devices in the same group. In some embodiments, proximity to a sound-generating device may be determined by direct wireless communication (e.g., Bluetooth) and/or ad hoc wireless networks. In some embodiments, proximity to a sound-generating device may be determined by network connections, e.g., strength of signal. In some embodiments, proximity to a sound-generating device may be determined by requesting each available device with a connected microphone to measure sound level and using the highest measured sound level.

In some embodiments, the SDM engine may instruct the sound-generating device to play a sound (e.g., at a frequency inaudible to humans) that may be captured by all microphones in a designated area and used to determine proximity of potential sound level measurement devices. In some embodiments, the SDM engine may instruct one or more selected sound level measuring devices to capture audio for sound level measurement of the sound-generating device. In some embodiments, those instructions may be transmitted directly to a device or may require transmission to one device (e.g., via network) for relaying to another (e.g., via Bluetooth).

At step 512, the SDM engine receives a measured sound level of the sound-generating device. For example, in scenario 100 of FIG. 1, a sound measuring device such as device 110, device 112, or device 114 may measure the sound level of sound 104 provided by the sound-generating device, device 101, and transmit the sound data to management server 124 via the network. In some embodiments, the SDM engine receives a sound and measures sound level of the sound-generating device, e.g., using a known microphone sensitivity variable for the capturing device. For example, in scenario 100 of FIG. 1, device 114 (e.g., a remote control) may capture a portion of sound 104 and transmit sound data device 101 (e.g., a television) for relayed transmission to management server 124 via network 120. An exemplary measured sound reading for a television might be 73 dB.

At step 514, the SDM engine determines if the measured sound level exceeds a threshold from the loudness policy. For instance, if the loudness policy includes a limit of, e.g., 70 dB (at night), then a measured sound reading of 73 dB exceeds the threshold. Likewise, if the loudness policy includes a limit of, e.g., 80 dB (during daylight hours), then a measured sound reading of 73 dB does not exceed the threshold. In some cases, a loudness policy may have multiple thresholds and a comparison to the lowest threshold may be necessary. For instance, if the loudness policy includes a television limit of, e.g., 80 dB, but the room (e.g., a child's bedroom or a hotel room) has a limit of, e.g., 68 dB, then a measured sound reading of 73 dB from the TV exceeds the room threshold.

If, at step 514, the SDM engine determines the measured sound level exceeds the threshold from the loudness policy then, at step 516, the SDM engine issues a command to the sound-generating device to reduce the volume. In some embodiments, a sound management server may transmit a command to a sound-generating device to, e.g., lower the volume. For instance, using External Control Protocol (ECP), a media device may be controlled over a network (e.g., a LAN) by providing a number of external control services. In some embodiments disclosed herein, communication of ECPs may allow control of a device's volume and/or loudness via network-transmitted control commands, “volume up,” “volume down,” and “mute,” if necessary. In some embodiments, volume may be set as a percentage (e.g., 55%) or as a rating on a scale such as a “level 5” on a scale of 0 to 10.

FIG. 5B depicts an illustrative flow diagram of a process for managing sound levels, in accordance with some embodiments of the disclosure. There are many ways for issuing a command when sound level is measured to be above a threshold and process 520 of FIG. 5B is an exemplary method. For instance, a sound may be received by a device, the sound-generating device may be identified, the sound level may be measured and compared to a threshold stored in a sound level policy associated with the identified sound-generating device, and a command may be issued to the sound-generating device if the measured sound level exceeds the threshold.

Some embodiments may utilize a SDM engine to perform one or more parts of process 520 stored and executed by one or more of the processors and memory of a device and/or server such as those depicted in FIGS. 6 and 7. For example, at least a portion of a SDM engine may run on a component of a television, set-top box, computer, streaming device, smartphone, tablet, smart speaker, server, or other device able to communicate via a network.

At step 522, a SDM engine receives a sound. For example, in scenario 100, one or more of device 110, device 112, and device 114 may capture audio being played in the room.

At step 524, the SDM engine accesses other managed devices on network. For instance, in scenario 100 of FIG. 1, device 112 may access managed devices 101, 110, and 114 on network 120. Generally, connected devices offering external control services may be discoverable using SSDP (Simple Service Discovery Protocol) as part of IETF standard network protocols and compatible APIs. In some embodiments, when accessing each device, a request to update status may be made so that data describing the device status and metadata describing any content being played by each device may be readily accessible. In some embodiments, a device may query a management sever and/or a database for a list of managed devices on a network. For instance, device 110 may discover other devices (e.g., device 101, device 112, and device 114) on network 120 via communication with management server 124.

At step 526, the SDM engine identifies the sound-generating device. For instance, in scenario 100 of FIG. 1, device 112 identify device 101 as the sound-generating device by, e.g., matching an audio fingerprint of the captured sound to metadata of the content, as communicated with management server 124. FIG. 5C describes an exemplary procedure for identifying a sound-generating device on a network by using an audio fingerprint.

At step 522, the SDM engine accesses a loudness policy. For instance, in scenario 100 of FIG. 1, device 112 may access a loudness policy (associated with the room, device 101, and/or other related rules) from management policies database 126 via management server 124. In some embodiments, for example, a sound management policies database may store a profile for one or more teenaged children's rooms in a house to limit the streaming music noise levels to be below a certain sound level, e.g., 70 dB, after 7 p.m. A sound management policies database may store a profile for the first floor of a condominium building that requires stereo noise levels to be below a certain sound level, e.g., 60 dB, after 11 p.m., while storing another profile that permits noise levels up to 65 dB for televisions at the same time. In some embodiments, a sound management policies database may store a profile only permitting noise above 85 dB (but below 90 dB) during the hours of 11 a.m. until 3 p.m. In some embodiments, an interface on a connected device may access a management server to configure policies saved in a sound management policies database. For instance, an SDM application may allow setting of one or more sound level thresholds, associated times, and associated devices/locations. FIG. 3A depicts an interface for setting of sound level thresholds for one or more sound management policies.

At step 530, the SDM engine determines a sound level of the sound-generating device. In some embodiments, the SDM engine may calculate a sound level based on the previously captured sound. For example, in scenario 100 of FIG. 1, device 112 may measure the sound level of sound 104 provided by the sound-generating device, device 101. In some embodiments, a connected device may receive a sound and calculate a measurement for a sound level of the sound-generating device, e.g., using a known microphone sensitivity variable for the sound measuring device. For example, in scenario 100 of FIG. 1, device 114 (e.g., a remote control) may capture a portion of sound 104 and transmit it to sound data device 101 (e.g., a television) for calculation of a sound level. Even though device 101 might be aware of a volume setting on the device, a calculation based on captured audio by the paired remote may generate a more accurate sound level reading. An exemplary measured sound reading for a television might be 78 dB.

At step 532, the SDM engine determines if the measured sound level exceeds a threshold from the loudness policy. For instance, if the loudness policy includes a limit of, e.g., 75 dB (at night), then a measured sound reading of 78 dB exceeds the threshold. Likewise, if the loudness policy includes a limit of, e.g., 80 dB (during daylight hours), then a measured sound reading of 78 dB does not exceed the threshold. In some cases, a loudness policy may have multiple thresholds and a comparison to the lowest threshold may be necessary. For instance, if the loudness policy includes a television limit of, e.g., 85 dB, but the building (e.g., a hotel, condo, or office building) has a limit of, e.g., 76 dB, then a measured sound reading of 78 dB from the TV exceeds the building threshold.

If, at step 532, the SDM engine determines the measured sound level exceeds the threshold from the loudness policy then, at step 534, the SDM engine issues a command to the sound-generating device to reduce the volume. In some embodiments, the sound measuring device may directly transmit a command to a sound-generating device to, e.g., lower the volume. In some embodiments, the sound measuring device may request that the sound management server transmit a command to a sound-generating device to, e.g., lower the volume. For instance, using External Control Protocol (ECP), a media device may be controlled over a network (e.g., a LAN) by providing a number of external control services. In some embodiments disclosed herein, communication of ECPs may allow control of a device's volume and/or loudness via network-transmitted control commands, “volume up,” “volume down,” and “mute,” if necessary. In some embodiments, volume may be set as a percentage (e.g., 53%) or as a rating on a scale such as a “level 4” on a scale of 0 to 10.

FIG. 5C describes a procedure for identifying a sound-generating device on a network using an audio fingerprint, in accordance with some embodiments of the disclosure. There are many ways to identify which connected device is making noise and process 540 of FIG. 5C is an exemplary method. For instance, a sound may be received by a device, an audio fingerprint generated for the sound, fingerprints of audio played by other managed devices on the network may be accessed, and the corresponding device playing the matching audio fingerprint is identified.

Some embodiments may utilize a SDM engine to perform one or more parts of process 520 stored and executed by one or more of the processors and memory of a device and/or server such as those depicted in FIGS. 6 and 7. For example, at least a portion of a SDM engine may run on a component of a television, set-top box, computer, streaming device, smartphone, tablet, smart speaker, server, or other device able to communicate via a network.

At step 542, a SDM engine receives a sound. For example, in scenario 100, one or more of device 110, device 112, and device 114 may capture audio being played in the room. For instance, in scenario 100 of FIG. 1, a device (e.g., device 110) and/or management server (e.g., management server 124) may receive a sound input (e.g., sound 104).

At step 544, the SDM engine generates an input fingerprint of the sound input. For instance, an acoustic fingerprint may be used as a condensed digital summary generated from an audio signal for the purpose of identifying an audio sample or quickly locate similar items in an audio database.

Therefore, a smartphone may be able to confirm by fingerprinting the background “noise,” which is potentially the TV program, in order to determine the source of the content (e.g., which device is too loud).

At step 546, the SDM engine accesses managed devices. Generally, accessing each device is to assess the status of each device and find out what is being played back by one or more devices. For instance, in scenario 100, the SDM engine may access devices on network 120 (e.g., device 101, device 112, and device 114). In some embodiments, a management server may have already received updates from such devices and data, such as device data 375 of FIG. 3B, may be recorded identifying a status (and content being played) for each device.

At step 548, the SDM engine accesses fingerprints for sounds generated by the managed devices on the network. For instance, in scenario 100, the SDM engine accesses a fingerprint associated with content 102 played on device 101.

At step 550, the SDM engine compares the input fingerprint to fingerprints for device sounds. For instance, the system would compare the fingerprint from the captured audio to a known fingerprint of the content from the accessed devices.

At step 552, the SDM engine determines if a fingerprint for any device sounds matches the input fingerprint. If there is a match of a known fingerprint of the content from the accessed devices, then the corresponding device is identified as the subject device. In some embodiments, the matched device may be a device violating a sound limit policy.

At step 554, the SDM engine provides the managed device associated with the matching fingerprint as an identified device. In scenario 100, device 101 would be determined to be the match. For instance, if device 114 captures audio in the room, the fingerprint would match a fingerprint from the metadata of device 101.

FIG. 6 is a diagram of illustrative devices, in accordance with some embodiments of the disclosure. Device 600 may be implemented by a device or system, e.g., a device providing a display to a user, or any other suitable control circuitry configured to generate a display to a user of content. For example, device 600 of FIG. 6 can be implemented as equipment 601. In some embodiments, equipment 601 may include set-top box 616 that includes, or is communicatively coupled to, display 612, audio equipment 614 (e.g., speakers or headphones), microphone 616, camera 618, and user input interface 610. In some embodiments, display 612 may include a television display or a computer display. In some embodiments, user interface input 610 is a remote-control device. Set-top box 616 may include one or more circuit boards. In some embodiments, the one or more circuit boards include processing circuitry, control circuitry, and storage (e.g., RAM, ROM, Hard Disk, Removable Disk, etc.). In some embodiments, circuit boards include an input/output path. Each one of device 600 and equipment 601 may receive content and receive data via input/output (hereinafter “I/O”) path 602. I/O path 602 may provide content and receive data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communication paths (described below). I/O functions may be provided by one or more of these communication paths but are shown as a single path in FIG. 6 to avoid overcomplicating the drawing. While set-top box 616 is shown in FIG. 6 for illustration, any suitable computing device having processing circuitry, control circuitry, and storage may be used in accordance with the present disclosure. For example, set-top box 616 may be replaced by, or complemented by, a personal computer (e.g., a notebook, a laptop, a desktop), a smartphone (e.g., device 600), a tablet, a network-based server hosting a user-accessible client device, a non-user-owned device, any other suitable device, or any combination thereof.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for an application SDM engine stored in memory (e.g., storage 608). Specifically, control circuitry 604 may be instructed by the application to perform the functions discussed above and below. For example, the application may provide instructions to control circuitry 604 to determine screen positions. In some implementations, any action performed by control circuitry 604 may be based on instructions received from the application.

In some client/server-based embodiments, control circuitry 604 includes communications circuitry suitable for communicating with an application server. A SDM engine may be a stand-alone application implemented on a device or a server. A SDM engine may be implemented as software or a set of executable instructions. The instructions for performing any of the embodiments discussed herein of the SDM engine may be encoded on non-transitory computer-readable media (e.g., a hard drive, random-access memory on a DRAM integrated circuit, read-only memory on a BLU-RAY disk, etc.) or transitory computer-readable media (e.g., propagating signals carrying data and/or instructions). For example, in FIG. 6, the instructions may be stored in storage 608, and executed by control circuitry 604 of a device 600.

In some embodiments, a SDM engine may be a client/server application where only the client application resides on device 600 (e.g., devices 702A-F), and a server application resides on an external server (e.g., server 706). For example, a SDM engine may be implemented partially as a client application on control circuitry 604 of device 600 and partially on server 706 as a server application running on control circuitry. Server 706 may be a part of a local area network with one or more of devices 702A-F or may be part of a cloud computing environment accessed via the internet. In a cloud computing environment, various types of computing services for performing searches on the internet or informational databases, providing storage (e.g., for a database or scoring table) or parsing data are provided by a collection of network-accessible computing and storage resources (e.g., server 706), referred to as “the cloud.” Device 600 may be a cloud client that relies on the cloud computing capabilities from server 706 to determine sound levels and issue control commands to other devices by the SDM engine. When executed by control circuitry of server 706, the SDM engine may instruct the control circuitry to generate the SDM engine output (e.g., sound levels and/or commands) and transmit the generated output to one or more of devices 702A-F. The client application may instruct control circuitry of the receiving device 702A-F to generate the SDM engine output. Alternatively, one or more of devices 702A-F may perform all computations locally via control circuitry 604 without relying on server 706.

Control circuitry 604 may include communications circuitry suitable for communicating with a SDM engine server, a table or database server, or other networks or servers. The instructions for carrying out the above-mentioned functionality may be stored and executed on the application server 706. Communications circuitry may include a cable modem, an integrated-services digital network (ISDN) modem, a digital subscriber line (DSL) modem, a telephone modem, an ethernet card, or a wireless modem for communications with other equipment, or any other suitable communications circuitry. Such communications may involve the internet or any other suitable communication network or paths. In addition, communications circuitry may include circuitry that enables peer-to-peer communication of devices, or communication of devices in locations remote from each other.

Memory may be an electronic storage device such as storage 608, which is part of control circuitry 604. As referred to herein, the phrase “electronic storage device” or “storage device” should be understood to mean any device for storing electronic data, computer software, or firmware, such as random-access memory, read-only memory, hard drives, optical drives, solid state devices, quantum storage devices, gaming consoles, gaming media, or any other suitable fixed or removable storage devices, and/or any combination of the same. Storage 608 may be used to store various types of content described herein as well as content guidance data described above. Nonvolatile memory may also be used (e.g., to launch a boot-up routine and other instructions). Cloud-based storage, for example, (e.g., on server 706) may be used to supplement storage 608 or instead of storage 608.

A user may send instructions to control circuitry 604 using user input interface 610. User input interface 610 and display 612 may be any suitable interface such as a touchscreen, touchpad, or stylus and/or may be responsive to external device add-ons, such as a remote control, mouse, trackball, keypad, keyboard, joystick, voice recognition interface, or other user input interfaces. Display 612 may include a touchscreen configured to provide a display and receive haptic input. For example, the touchscreen may be configured to receive haptic input from a finger, a stylus, or both. In some embodiments, equipment device 600 may include a front-facing screen and a rear-facing screen, multiple front screens, or multiple angled screens. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 616.

Audio equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio equipment 614 may be provided as integrated with other elements of each one of device 600 and equipment 601 or may be stand-alone units. An audio component of videos and other content displayed on display 612 may be played through speakers (or headphones) of audio equipment 614. In some embodiments, audio may be distributed to a receiver (not shown), which processes and outputs the audio via speakers of audio equipment 614. In some embodiments, for example, control circuitry 604 is configured to provide audio cues to a user, or other audio feedback to a user, using speakers of audio equipment 614. There may be a separate microphone 616 or audio equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

An application (e.g., for generating a display) may be implemented using any suitable architecture. For example, a stand-alone application may be wholly implemented on each one of device 600 and equipment 601. In some such embodiments, instructions of the application are stored locally (e.g., in storage 608), and data for use by the application is downloaded on a periodic basis (e.g., from an out-of-band feed, from an internet resource, or using another suitable approach). Control circuitry 604 may retrieve instructions of the application from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected. An application and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 604 may allow a user to provide user profile information or may automatically compile user profile information. For example, control circuitry 604 may access and monitor network data, video data, audio data, processing data, participation data from a participant profile. In some embodiments, control circuitry 604 may calculate several scores, such as a readiness score, based on profile data. Control circuitry 604 may store scores in a database and the database may be linked to a user profile. Additionally, control circuitry 604 may obtain all or part of other user profiles that are related to a particular user (e.g., via social media networks), and/or obtain information about the user from other sources that control circuitry 604 may access. As a result, a user can be provided with a unified experience across different devices.

In some embodiments, the application is a client/server-based application. Data for use by a thick or thin client implemented on each one of device 600 and equipment 601 is retrieved on demand by issuing requests to a server remote from each one of device 600 and equipment 601. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 610 and transmit those inputs to the remote server for processing and generating the corresponding displays. For example, device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to device 600 for presentation to the user.

As depicted in FIG. 7, one or more of devices 702A-F may be coupled to communication network 704. Communication network 704 may be one or more networks including the internet, a mobile phone network, mobile voice or data network (e.g., a 5G or 4G or LTE network), cable network, public switched telephone network, Bluetooth, or other types of communication network or combinations of communication networks. Thus, devices 702A-F may communicate with server 706 over communication network 704 via communications circuitry described above. In should be noted that there may be more than one server 706, but only one is shown in FIG. 7 to avoid overcomplicating the drawing. The arrows connecting the respective device(s) and server(s) represent communication paths, which may include a satellite path, a fiber-optic path, a cable path, a path that supports internet communications (e.g., IPTV), free-space connections (e.g., for broadcast or other wireless signals), or any other suitable wired or wireless communication path or combination of such paths.

In some embodiments, the application is downloaded and interpreted or otherwise run by an interpreter or virtual machine (e.g., run by control circuitry 604). In some embodiments, the application may be encoded in the ETV Binary Interchange Format (EBIF), received by control circuitry 604 as part of a suitable feed, and interpreted by a user agent running on control circuitry 604. For example, the application may be an EBIF application. In some embodiments, the application may be defined by a series of JAVA-based files that are received and run by a local virtual machine or other suitable middleware executed by control circuitry 604.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method of controlling a device based on measured sound levels, the method comprising:
determining a sound device, of a plurality of devices, is outputting a sound;
selecting a measuring device, from a plurality of sound measuring devices, near the sound device;
accessing a sound policy associated with the sound device, the sound policy comprising a predetermined sound threshold;
receiving, from the selected measuring device, a measured sound level for the sound device;
determining if the measured sound level exceeds the predetermined threshold; and
in response to determining the measured sound level exceeds the predetermined threshold, issuing a command to the sound device to reduce intensity for the sound being output.

2. The method of claim 1 further comprising:
receiving, from the selected measuring device, a second sound level;
determining whether the second sound level is equal to a predefined minimum threshold from the sound policy; and
in response to determining that the second sound level is equal to predefined minimum threshold from the sound policy, issuing a command to a second sound device, near the sound device, to reduce intensity for a corresponding output sound.

3. The method of claim 1, wherein determining the sound device, of the plurality of devices, is outputting a sound comprises accessing data describing a status for each of the plurality of devices.

4. The method of claim 1, wherein selecting the measuring device, from the plurality of sound measuring devices, near the sound device comprises accessing data describing a location for the sound device and a location for each of the plurality of sound measuring devices.

5. The method of claim 4, wherein the data describing the location for the sound device matches the corresponding location for the selected measuring devices.

6. The method of claim 1, wherein selecting the measuring device, from the plurality of sound measuring devices, near the sound device comprises accessing data describing the output sound for the sound device and a sample capture for each of the plurality of sound measuring devices.

7. The method of claim 1, wherein the accessing the sound policy associated with the sound device comprises selecting the predetermined sound threshold from a plurality of thresholds based on a corresponding day and time.

8. The method of claim 1, wherein the measured sound level was calculated based on a measured intensity level of the sound and a known sensitivity of a microphone associated with the selected measuring device.

9. The method of claim 1, wherein the command comprises an instruction to lower volume of the device.

10. The method of claim 9, wherein the command is transmitted via a network connection to the device.

11. A system for controlling a device based on measured sound levels, the system comprising:
input/output circuitry configured to:
access a sound policy associated with a sound device, the sound policy comprising a predetermined sound threshold;
receive, from a measuring device, a measured sound level for the sound device;
processing circuitry configured to:
determine the sound device, from a plurality of devices, based on whether the sound device is outputting a sound;
select the measuring device, from a plurality of sound measuring devices, based on proximity to the sound device;
determine if the measured sound level exceeds the predetermined threshold; and
the input/output circuitry further configured to, in response to determining the measured sound level exceeds the predetermined threshold, issue a command to the sound device to reduce intensity for the sound being output.

12. The system of claim 11, wherein
the processing circuitry is further configured to determine whether a second sound level is equal to a predefined minimum threshold from the sound policy;
the input/output circuitry is further configured to:
receive, from the selected measuring device, the second sound level; and
issue, in response to determining that the second sound level is equal to predefined minimum threshold from the sound policy, a command to a second sound device, near the sound device, to reduce intensity for a corresponding output sound.

13. The system of claim 11, wherein the processing circuitry is further configured to determine the sound device, of the plurality of devices, is outputting a sound by accessing data describing a status for each of the plurality of devices.

14. The system of claim 11, wherein the processing circuitry is further configured to select the measuring device, from a plurality of sound measuring devices, near the sound device by accessing data describing a location for the sound device and a location for each of the plurality of sound measuring devices.

15. The system of claim 14, wherein the data describing the location for the sound device matches the corresponding location for the selected measuring devices.

16. The system of claim 11, wherein the processing circuitry is further configured to select the measuring device, from the plurality of sound measuring devices, near the sound device by accessing data describing the output sound for the sound device and a sample capture for each of the plurality of sound measuring devices.

17. The system of claim 11, wherein the processing circuitry is further configured to access the sound policy associated with the sound device by selecting the predetermined sound threshold from a plurality of thresholds based on a corresponding day and time.

18. The system of claim 11, wherein the measured sound level was calculated based on a measured intensity level of the sound and a known sensitivity of a microphone associated with the selected measuring device.

19. The system of claim 11, wherein the command comprises an instruction to lower volume of the device.

20. The system of claim 19, wherein the command is transmitted via a network connection to the device.

21-30. (canceled)
